(19) United States
(12) Patent Application Publication
(10) Pub. No.: US 2017/0031960 A1
(43) Pub. Date: Feb. 2, 2017

(54) INFORMATION RECORDING DEVICE AND DATA ERASING METHOD

(71) Applicant: Panasonic Intellectual Property Management Co., Ltd., Osaka (JP)

(72) Inventors: Toshiaki TAKASU, Osaka (JP); Shinichi KIMURA, Osaka (JP); Takeharu YAMAMOTO, Osaka (JP)

(21) Appl. No.: 15/221,916

(22) Filed: Jul. 28, 2016

(30) Foreign Application Priority Data
Jul. 31, 2015 (JP) 2015-152499
Jun. 7, 2016 (JP) 2016-113179

(51) Int. Cl. G06F 17/30; G06F 12/0804; G06F 3/06

(52) U.S. Cl. CPC G06F 17/30303; G06F 17/30309; G06F 3/0604; G06F 3/0629; G06F 3/0677; G06F 12/0804; G06F 2212/20

(57) ABSTRACT

An information recording device includes: a storage in which a database is stored, the database managing data recorded in an optical disk and history data associated with the data; and a controller that controls recording, update, and erase of the data with respect to the optical disk. The history data is pre-update data when the data recorded in the optical disk is updated. The controller determines whether at least one piece of history data associated with target data exists when the target data recorded in the optical disk is erased, and the controller erases the target data and the history data associated with the target data on the optical disk when at least the one piece of history data associated with the target data exists.

### BACKGROUND

1. Technical Field

The present disclosure relates to a method and a device for erasing data recorded in a write-once optical disk.

2. Description of Related Art

A write-once optical disk such as a DVD-R and a BD-R is a recording medium in which a recording mark once recorded cannot be rewritten. PTL 1 discloses an information recording and reproducing device that erases data recorded in the write-once optical disk.

The information recording and reproducing device of Unexamined Japanese Patent Publication No. 2005-038490 includes data processing means, recording means, and erase means. The data processing means generates processing data in which recording data to be recorded in the recording medium is processed and restoration data necessary for restoration of the recording data from the processing data. The recording means records the recording data as the processing data and the restoration data, and the processing data and the restoration data are separately recorded in different positions on the recording medium. The erase means puts the restoration data recorded in the recording medium into an unreadable state when the recording data is erased. The configuration of the information recording and reproducing device of Unexamined Japanese Patent Publication No. 2005-038490 can erase the data recorded in the write-once recording medium such that the data is completely unreadable.

### SUMMARY

The present disclosure provides an information recording device and a data erasing method for erasing the data recorded in the write-once optical disk.

A first aspect of the present disclosure provides an information recording device that can erase data recorded in a write-once optical disk. The information recording device includes: a storage in which a database is stored, the database managing the data recorded in the optical disk and history data associated with the data; and a controller that controls recording, update, and erase of the data with respect to the optical disk. The history data is pre-update data when the data recorded in the optical disk is updated. The controller determines, when target data recorded in the optical disk is erased, whether at least one piece of history data associated with the target data exists. The controller erases the target data and the history data associated with the target data on the optical disk when at least the one piece of history data associated with the target data exists.

A second aspect of the present disclosure provides a data erasing method for erasing target data recorded in a write-once optical disk. After data recorded in the optical disk is updated on the optical disk, pre-updated data is managed as history data for post-update data. The data erasing method includes: determining whether at least one piece of history data associated with the target data exists on the optical disk; and erasing the target data and the history data associated with the target data when at least the one piece of history data associated with the target data exists.

### BRIEF DESCRIPTION OF THE DRAWINGS

FIG. 1 is a hardware block diagram illustrating an information recording device according to an exemplary embodiment;

FIG. 2 is a functional block diagram illustrating the information recording device of the exemplary embodiment;

FIG. 3 is a view illustrating a data structure of file information in a database;

FIG. 4A is a view illustrating a logical configuration of an optical disk;

FIG. 4B is a view illustrating the logical configuration of the optical disk;

FIG. 5 is a view illustrating a state change on the disk during file update;

FIG. 6 is a flowchart illustrating file update processing;

FIG. 7 is a view illustrating a directory configuration change associated with file erase;

FIG. 8 is a flowchart illustrating file erasing processing;

FIG. 9 is a flowchart illustrating processing of physically erasing a file;

FIG. 10A is a view illustrating the state change on the disk during file erase;

FIG. 10B is a view illustrating the state change on the disk during the file erase;

FIG. 11 is a view illustrating physical erase of the file in a recording layer of a write-once optical disk; and

FIG. 12 is a flowchart illustrating scheduled synchronization processing and the physical erase processing performed in association therewith.

### DETAILED DESCRIPTION

Hereinafter, an exemplary embodiment will be described in detail with reference to the drawings. However, the detailed description more than necessary is occasionally omitted. For example, the detailed description of an already known item or overlapping description of a substantially identical configuration is occasionally omitted. This is because unnecessary redundancy of the following description is avoided to facilitate understanding of those skilled in the art.

The inventors provide the accompanying drawings and the following description in order that those skilled in the art fully understand the present disclosure, but it is noted that claims are not limited to the drawings and the description.

### First Exemplary Embodiment

### 1-1. Configuration

### 1-1-1. Information Recording Device

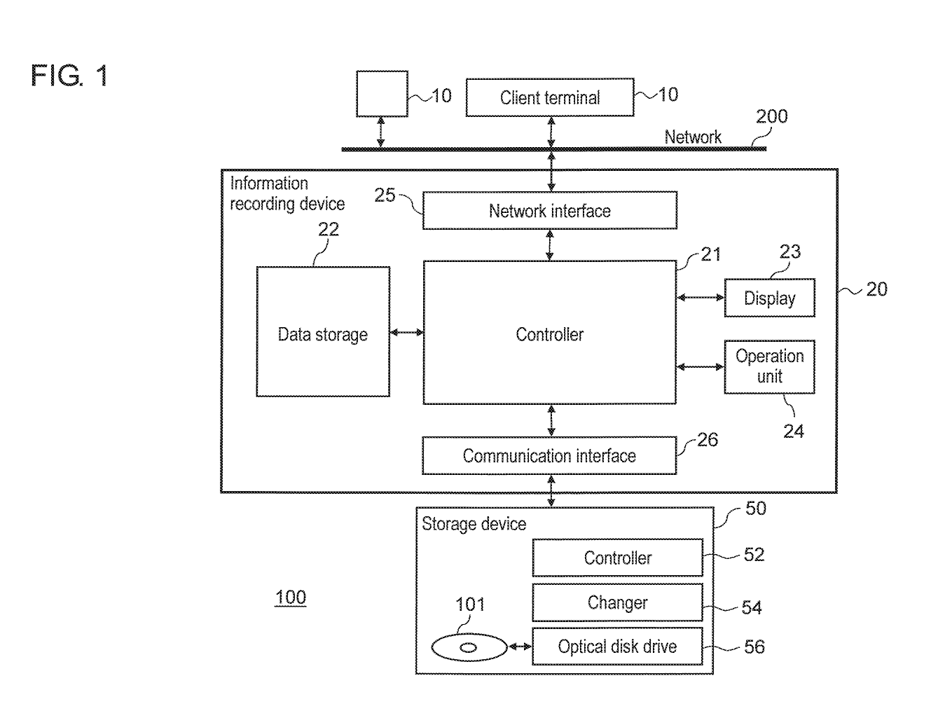

FIG. 1 illustrates a configuration of information recording device 100 according to an exemplary embodiment. Referring to FIG. 1, information recording system 100 includes information recording device 20 and storage device 50. Information recording system 100 is connected to client terminal 10 through network 200.

Client terminal 10 is a computer uses a function or data provided from information recording system 100 according to a user operation (instruction). According to the user operation, client terminal 10 issues a command to record a file (data) in storage device 50 or a command to read the file (data) recorded in storage device 50 to information recording system 100.

According to the command received from client terminal 10, information recording device 20 controls storage device 50 to record and read the data in and from a recording medium (optical disk) of storage device 50.

Information recording device 20 includes controller 21 that controls entire operation of information recording device 20, display 23 that displays various pieces of information, operation unit 24 that receives the user operation, and data storage 22 in which data and a program are stored. Information recording device 20 further includes communication interface 26 that allows a connection to an external device and network interface 25 that allows a connection to network 200.

For example, display 23 includes a liquid crystal display or an organic EL display, for example. Operation unit 24 includes various components, such as a keyboard, a mouse, a touchpad, and a button, which are operated by the user.

Communication interface 26 is a circuit (module) that connects storage device 50 to information recording device 20. Communication interface 26 conducts communication pursuant to communication standards such as SAS (Serial Attached SCSI).

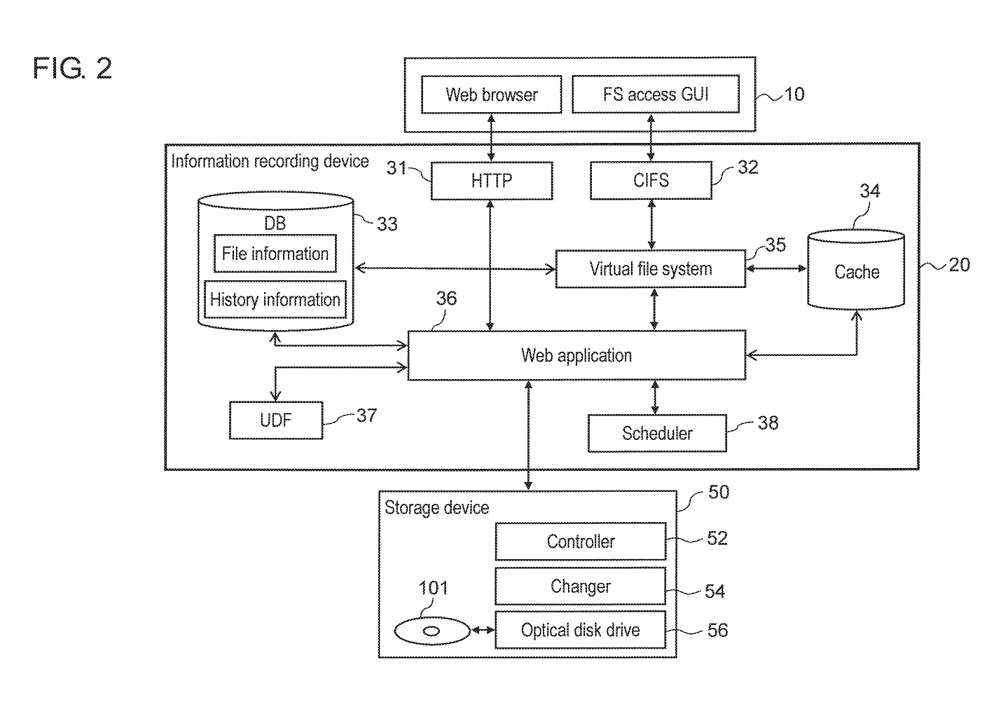

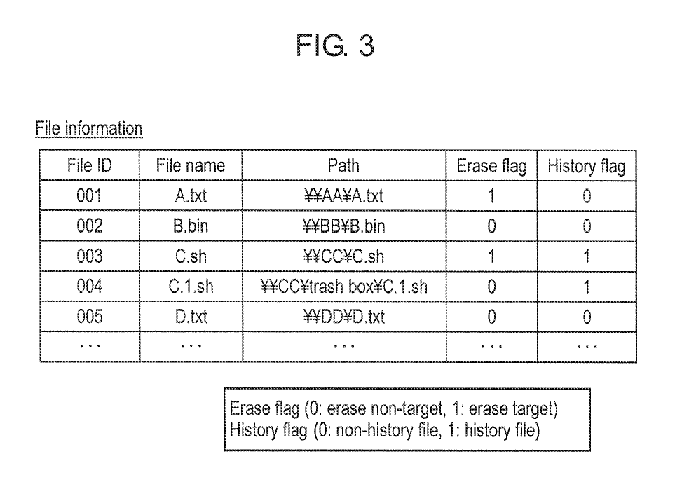

Network interface 25 is a circuit (module) that connects information recording device 20 to a network (such as LAN and WAN) through a wireless or wired communication line. Network interface 25 conducts communication pursuant to communication standards such as IEEE802.3, IEEE802.11a/11b/11g/11ac, and Win, Data storage 22 is a recording medium in which a parameter, data, and a control program necessary for implementation of a predetermined function are stored, and data storage 22 includes a hard disk drive (HDD), Data storage 22 may include a semiconductor storage device (SSD). As described later, database 33 (see FIGS. 2, 3) is stored in data storage 22, and data storage 22 also acts as cache 34 (see FIG. 2) in which the data to be recorded in the optical disk and the data read from the optical disk are temporarily stored.

Controller 21 includes a CPU or a MPU, and executes a control program (software) to implement a predetermined function. For example, the control program is stored in data storage 22.

Information recording device 20 includes a RAM (not illustrated) including a semiconductor device such as a DRAM and an SRAM. The data is temporarily stored in the RAM, and the RAM also acts as a working area of controller 21.

Storage device 50 is a device that accommodates optical disk 101 of the recording medium, and records and reproduces the data in and from optical disk 101 under the control of information recording device 20. Storage device 50 includes controller 52, changer 54, and optical disk drive 56. Controller 52 controls entire operation of storage device 50. Controller 52 includes a CPU or a MPU, and executes the control program (software) to implement a predetermined function. Alternatively, the function of controller 52 may be implemented by controller 21. Optical disk drive 56 is a device that writes the data in optical disk 101, and reads the data from optical disk 101. Changer 54 is a device that loads optical disk 101 on optical disk drive 56. The optical disk is a write-once optical disk such as a DVD-R and a BD-R.

FIG. 2 illustrates a functional block of information recording device 20 of the exemplary embodiment. Controller 21 executes the control program to implement each block (function) of information recording device 20 in FIG. 2.

Client terminal 10 receives the user operation with a Web browser as a GUI. For example, the Web browser is Internet Explorer (products of Microsoft). The user can perform the user operation (instruction) to record, move, and reproduce the data through the GUI with respect to information recording system 100 (optical disk 101). In this case, client terminal 10 transmits information to information recording system 100 based on an HTTP (Hypertext Transfer Protocol) protocol. Using the user interface (GUI) for accessing a file system (FS), client terminal 10 can issue an instruction to record or erase the data to information recording system 100 (optical disk 101). In this case, client terminal 10 transmits a command based on a CIFS (Common Internet File System) to information recording device 20.

HTTP module 31 is a function of receiving the information that is transmitted from client terminal 10 in pursuant to the HTTP protocol. CIFS module 32 is a function of receiving the CIFS-based command and data that are received from client terminal 10. For example, an erase command to erase the file may be received through HTTP module 31, and a command to update (rewrite) the file may be received through CIFS module 32.

Cache 34 is measures for temporarily storing the data to be written in optical disk 101 and the data read from optical disk 101. Cache 34 is implemented by data storage 22.

Virtual file system 35 is a file system that manages the file (data) stored in cache 34. Virtual file system 35 is a file system that logically manages a state of the file on optical disk 101. The state of the file is scheduled to be changed based on the instruction from client terminal 10, but not actually changed yet.

Web application 36 is a function of performing the following main operation of information recording device 20.

UDF (Universal Disk Format) 37 is a file system that manages the file (data) recorded in optical disk 101.

Scheduler 38 is a function of performing file synchronization processing (to be described in detail later) on optical disk 101 according to a schedule. For example, a manager sets the schedule, and a time period (a starting clock time and an ending clock time) in which the synchronization processing is performed is set with respect to optical disk 101. The synchronization processing is performed on optical disk 101 according to the set schedule in order to reflect the pieces of data stored in virtual file system 35 and cache 34 in optical disk 101. In the exemplary embodiment, physical erase processing is also performed in synchronization processing of scheduler 38.

Database (DB) 33 manages file information including information about a history of the file recorded in optical disk 101 and history information. For example, the file information manages whether the file recorded in optical disk 101 is scheduled to be erased. The file information also manages whether the file recorded in optical disk 101 is a history file. As used herein, the history file means a file that is invalid because of the update or erase of the file while being valid in past times. The file information also manages whether the file recorded in optical disk 101 is a synchronized file. As used herein, synchronization means that the state managed by virtual file system 35 is reflected in optical disk 101 with respect to a certain file. The history information is information managing a correspondence between a certain file and the history file associated with the file.

FIG. 3 illustrates a configuration example of the file information stored in database 33. The file information manages a file ID, a file name, a path indicating a place where the file is stored, an erase flag, and a history flag in each file recorded in optical disk 101. The erase flag indicates whether the file should be erased. A value “0” of the erase flag indicates that the file is not an erase target, and a value “1” indicates that the file is the erase target. The history flag indicates whether the file is the history file. The value “0” of the history flag indicates that the file is not the history file, and the value “1” indicates that the file is the history file.

### 1-1-2. Optical Disk

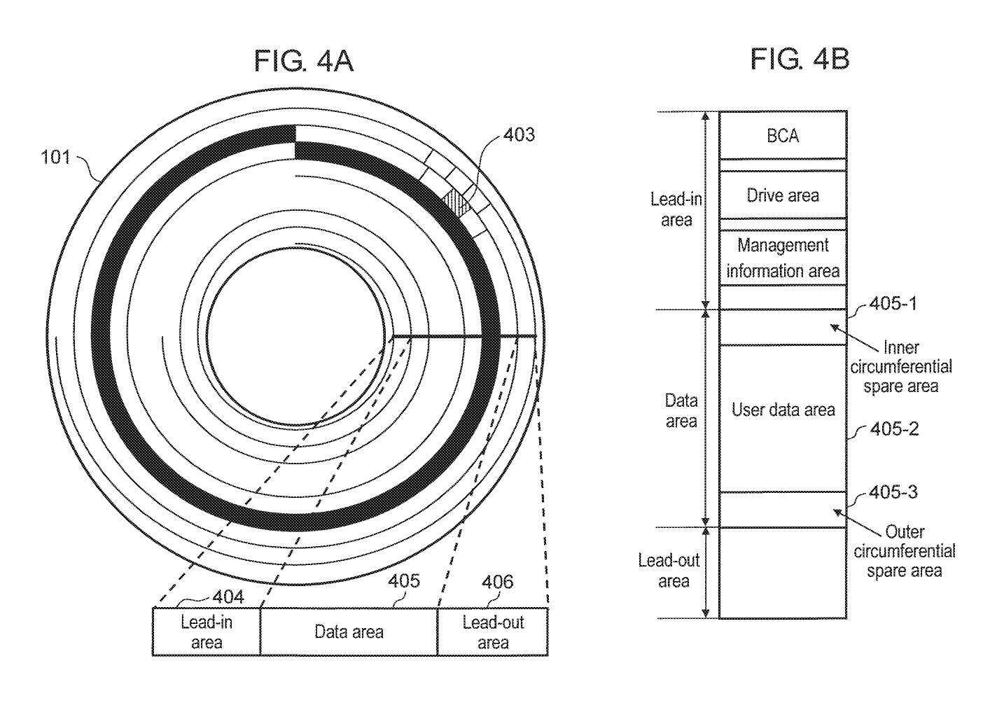

FIGS. 4A and 4B are views illustrating a logical configuration of the optical disk. Optical disk 101 of the exemplary embodiment is a write-once recording medium, FIG. 4A is a view illustrating areas of optical disk 101. Disc-shaped optical disk 101 includes at least one recording layer in which the information can be recorded and reproduced. In the recording layer, a groove is spirally formed from a center, and a track is formed in one of the groove and a land (an area between the grooves). Each track includes a plurality of finely-divided blocks 403. The groove of the track has wobbling, and address information (hereinafter, referred to as a “physical address”) indicating a detailed position on the disk is contained in the wobbling. The tracks may be provided in both the groove and the land to record the information, whereby recording density of the track could be improved.

For example, a Blu-ray (registered trademark) disk (BD) has a track width (track pitch) of 0.32 μm.

Block 403 is a unit of error correction, and a minimum data unit in which the recording or reproducing operation is performed. For example, block 403 is 32 Kbyte for the DVD (registered trademark), and is 64 Kbyte (=1 cluster) for the BD. When expressed in terms of sector (2 Kbyte), which is the minimum unit of the data of optical disk 101, 1 cluster=3.2 sectors. Hereinafter, the “cluster” and the “block” are used as the same meaning.

Optical disk 101 includes lead-in area 404, data area 405, and lead-out area 406. FIG. 4B is a view illustrating an area structure of optical disk 101. Data area 405 includes user data area 405-2, inner spare area 405-1, and outer spare area 405-3. User data is recorded in user data area 405-2. Each of inner spare area 405-1 and outer spare area 405-3 includes an alternate area that is used in alternate recording of a defective area detected in user data area 405-2.

Each of lead-in area 404 and lead-out area 406 includes an area where management information necessary for the recording and reproduction of the data in and from optical disk 101 is mainly recorded. Lead-in area 404 and lead-out area 406 act as a margin area where, even if the optical head overruns, an optical head can follow the track when the optical head accesses an edge of data area 405.

In lead-in area 404, the recording and reproduction are performed as needed. In lead-in area 404, unlike user data area 405-2, the user cannot directly perform the recording and reproduction. Lead-in area 404 includes a BCA (Burst Cutting Area), a drive area, and a management information area (DMA).

The BCA is a pre-recording area, which is formed on a barcode using a special device at a production stage of optical disk 101 while including disk-associated information or information unique to each disk. For example, the BCA is an area obtained by removing a reflection film using a laser. For example, information about a serial number unique to each optical disk 101 is stored in the BCA.

The drive area is an area where information recording system 100 (storage device 50) can freely record information necessary for its own control.

The management information area is an area in which the management information such as information about an area structure of data area 405 of optical disk 101, information about a defective block, and information indicating the recording state of optical disk 101 can be recorded.

Lead-in area 404 of optical disk 101 may further include an OPC area where recording power of optical disk drive 56 is adjusted and a pre-write area where tracking and focusing are adjusted.

### 1-2. Operation

The operation of the information recording system 100 having the above configuration will be described below. When receiving the user operation to record and reproduce the file directed to information recording system 100, client terminal 10 transmits information (hereinafter, referred to as a “command”) indicating the user operation, to information recording device 20. Information recording device 20 of information recording system 100 receives the command from client terminal 10. Controller 21 of information recording device 20 issues an instruction to storage device 50 according to the received command. According to the instruction from information recording device 20, storage device 50 (controller 52) records and reproduces the data in and from optical disk 101.

### 1-2-1. Synchronization Processing

When adding a new file to optical disk 101 of the recording medium or partially rewriting (updating) erasing the file according to the command from the client terminal, information recording system 100 of the exemplary embodiment records the data (file) to be recorded or updated on cache 34 before the file is added to optical disk 101.

Initially all the pieces of data recorded in optical disk 101 are loaded on cache 34. Then, the file is added, updated, or erased on cache 34 according to the command received from client terminal 10. Virtual file system 35 manages the file on cache 34. Then, processing (hereinafter, referred to as “synchronization processing”) of reflecting virtual file system 35 and the state of the data on cache 34 in optical disk 101 is performed. The storage state of the file (data) managed by virtual file system 35 is reflected in optical disk 101 through the synchronization processing, and optical disk 101 reaches the state in which the file is added, updated, or erased according to the command from client terminal 10.

Thus, when receiving the command from client terminal 10, information recording system 100 temporarily updates the data on cache 34 and then performs the synchronization processing on optical disk 101, thereby reflecting a content of cache 34 in optical disk 101. In the case where the command is received multiple times, the data on cache 34 is updated multiple times, and then the synchronization processing is performed on optical disk 101 only once. By this, the processing according to the command received multiple times can be reflected in optical disk 101. Accordingly, a frequency of loading optical disk 101 on optical disk drive 56 can be reduced, and efficiency of the processing of performing the recording on optical disk 101 can be improved.

### 1-2-2. File Update

In the exemplary embodiment, because optical disk 101 is a write-once optical disk, the data temporarily recorded in optical disk 101 cannot be updated (rewritten) or erased at the same physical position on optical disk 101. The processing of updating the file with respect to optical disk 101 in information recording system 100 will be described below.

Information recording device 20 of information recording system 100 receives an update command from client terminal 10 in order to partially rewrite the content of the file. The file name of the file to be updated, the position of the data to be updated, a length of the data to be updated, and the data to be updated are specified in the update command.

When receiving the update command from client terminal 10, information, recording device 20 updates virtual file system 35 while updating the data on cache 34 according to the update command.

Then, information recording device 20 performs the synchronization processing on optical disk 101 in order to reflect cache 34 and the state of the file managed by virtual file system 35 in optical disk 101.

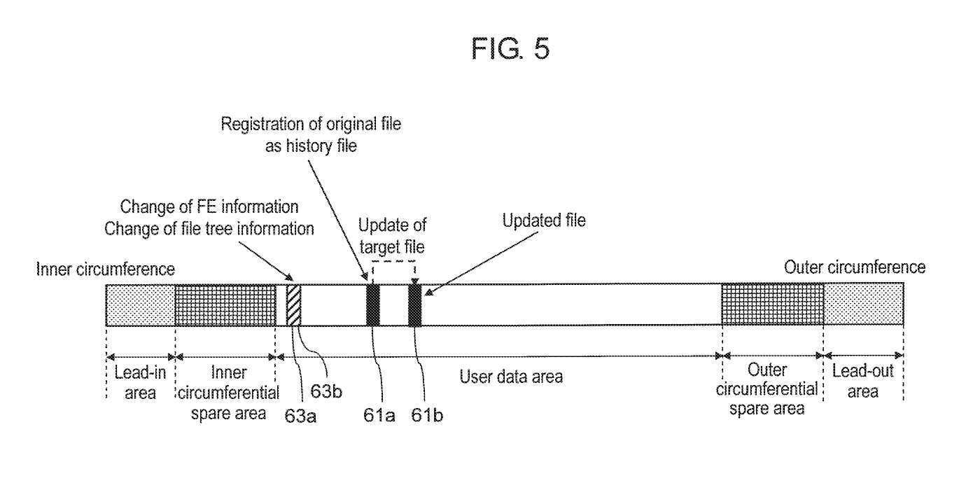

The processing on the optical disk 101 in updating (rewriting) the file (hereinafter, referred to as a “target file”) already recorded in the user data area of optical disk 101 will specifically be described with reference to FIG. 5.

In the case where target file 61a is updated, file 61a is updated (rewritten) according to the update command to a new file (hereinafter, referred to as an “updated file”) 61b. Updated file 61b is recorded in a free space (an area different from the area where original file 61a is recorded) of the user data area. At this point, because a recording place of updated file 61b is changed, a content of file entry (FE) information in the file system that manages the file in optical disk 101 is rewritten, and rewritten file entry information 63a is recorded in a predetermined free space (an area different from original file entry information) of the user data area.

Original file 61a of updated file 61b is renamed, and a storage place of the original file 61a is changed from a current holder to a trash box holder. The trash box holder is an example of a holder in which a logically invalid file caused by the erase is stored. That is, the data of renamed original file 61a still remains on optical disk 101. The data of original file 61a is managed as the “history file” on database 33. The file tree information about the history file (original file 61a) is changed so as to be stored in the trash box holder, and changed file tree information 63b is recorded in the free space. At this point, the user can check the history file (original file 61a) by referring to the trash box holder in optical disk 101.

A correspondence between updated file 61b and history file 61a associated with updated file 611 is managed by the history information in database 33. A plurality of pieces of file entry information and a plurality of pieces of file tree information optical disk 101 are generated together with the update of the file. Information indicating the latest file entry information and file tree information is stored in the lead-in area of optical disk 101 as the management information (not illustrated).

Thus, in information recording device 20 of the exemplary embodiment, the pre-update file is changed to the history file by the update of the file, and the history file is stored in the trash box holder.

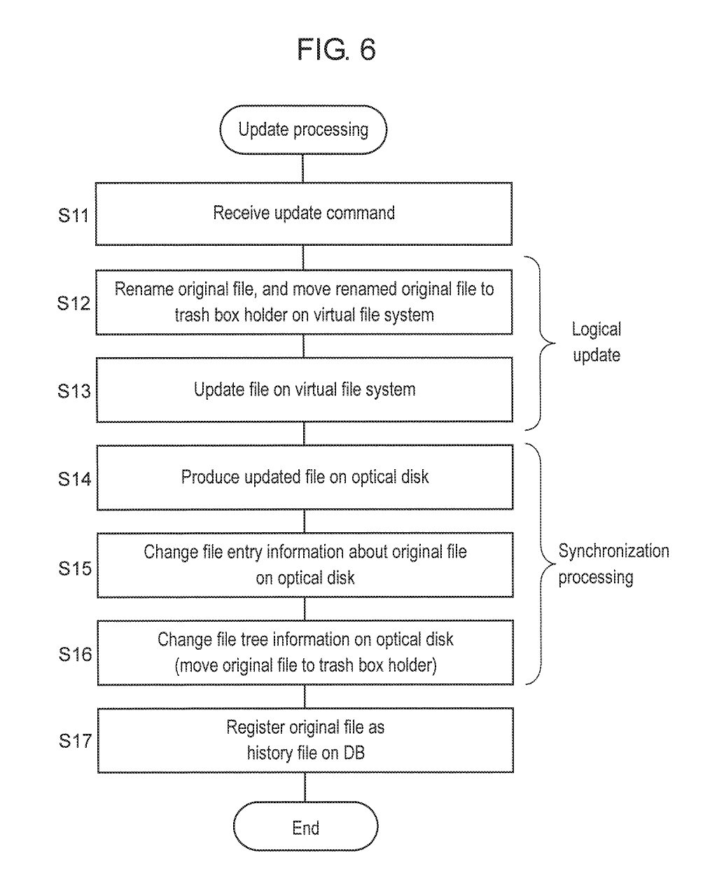

A flow of the processing of updating the file recorded in optical disk 101 will be described below with reference to a flowchart in FIG. 6.

When receiving the update command from client terminal 10 (S11), controller 21 of information recording device 20 updates the file according to the update command, and updates cache 34 and virtual file system 35 (S12 to S13). Specifically, controller 21 renames the file name of the file (original file) specified as an update target, and updates virtual file system 35 such that the renamed original file is stored in the trash box holder (S12). Controller 21 newly adds the updated file to cache 34 and virtual file system 35 in response to the updated command (S13).

The reception of the update command for the file having a file name “C.sh” stored in a holder “¥¥CC” will be described by way of example. Controller 21 renames the file name “C.sh” of the update target file to “C.1.sh”, and moves the original file having the renamed file name “C.1.sh” to the trash box holder. According to the command, controller 21 updates the update target file to generate new data (file), and adds the newly-generated data (file) to cache 34 and virtual file system 35 as the updated file of the file name “C.sh”. Therefore, on cache 34, the data updated by the file name “C.sh” is recorded in the holder “¥¥CC”, and the original file having the file name “C.sh.1” is recorded in the trash box holder.

Then, the synchronization processing is performed to synchronize (establish consistency) the logical state of optical disk 101, which is managed by virtual file system 35, with the actual physical state of optical disk 101. The synchronization processing may be performed at timing arbitrarily specified by the user, continuously performed after the processing of updating virtual file system 35, or performed at a clock time set by the function of scheduler 38.

In the synchronization processing, controller 21 issues an instruction to storage device 50 to record the updated file in optical disk 101 based on the file state managed by virtual file system 35 and cache 34 (S14). Therefore, for example, the data of updated file 61b is recorded in the free space (the area different from the area where original file 61a is recorded) of the optical disk 101 as illustrated in FIG. 5.

Then, controller 21 changes the file entry information of the original file on optical disk 101 (S15). Specifically, controller 21 changes the file entry information such that the file name of the original file is renamed, and such that the storage place of the original file is changed to the trash box holder. The changed file entry information is recorded in the area different from the original file entry.

Controller 21 changes the file tree information about the original file (S16). That is, controller 21 changes the file tree information about the original file such that the original file is stored in the trash box holder, and the changed file tree information is recorded in the area different from the original file tree information.

Controller 21 registers the original file as the history file in database 33 (S17). For example, in the case that the original file of the file name “C.sh” is updated in FIG. 3, the file name of the original file is changed to “C.1.sh”, the storage place of the original file is changed to the trash box holder (¥¥CC-trash box¥C.1.sh), the history flag is set to “1”, and the original file is registered in database 33.

Thus, the entity data of the updated file is newly recorded in optical disk 101, and the pre-update original file is moved to the trash box holder while the file name of the original file is changed. At this point, using client terminal 10, the user can check whether the original file exists in the trash box holder by browsing the trash box holder of optical disk 101 through virtual file system 35 or IMF 37.

### 1-2-3. File Erase

The file erase performed by information recording system 100 of the exemplary embodiment will be described below. When receiving the erase command from client terminal 10, information recording device 20 of information recording system 100 logically erases an erase target file. As used herein, the logical erase means that the storage place of the file is moved to the trash box holder on virtual file system 35. Since the actual data of the file effectively exists on optical disk 101 in the state in which the file is logically erased, the data of the file can be reproduced (read).

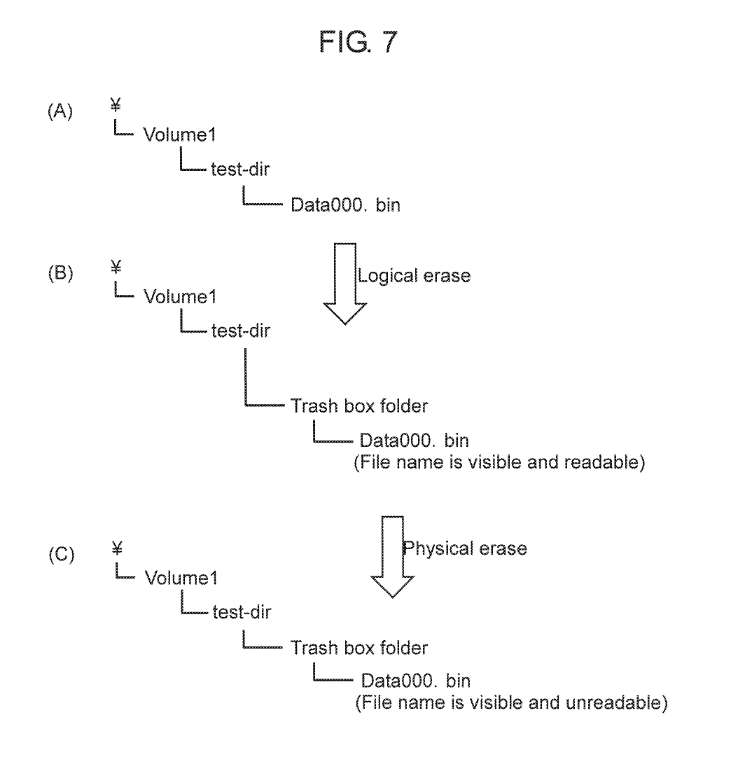

In the logical erase, information recording device 20 moves the erase target file to the trash box holder on virtual file system 35, and sets the erase flag to “1” for the erase target file and the history file associated with the erase target file (hereinafter, this is simply referred to as “sets the erase flag”). For example, in the case where the erase command to erase the file of Data000.bin is received while the file of Data000.bin in the directory of test-dir is stored as illustrated in (A) of FIG. 7, the file of Data000.bin is logically erased and moved to the trash box holder as illustrated in (B) of FIG. 7. In this state, the user can check the existence and content of the file of Data000.bin by browsing the trash box holder.

Then, information recording device 20 performs the synchronization processing on the optical disk 101 to reflect the disk state managed by virtual file system 35 in optical disk 101. Therefore; on optical disk 101, the erase target file is moved to the trash box holder together with the history file of the erase target file. Then, information recording device 20 performs physical erase on the file to which the erase flag is set. As used herein, the physical erase means that the data of the erase target file is overwritten so as to become irreproducible. After the physical erase, although the user can check the existence of the erased file by browsing the trash box holder, the user cannot reproduce (read) the data of the erased file. For example, as illustrated in (C) of FIG. 7, when the file of Data000.bin is physically erased, although the file name of the file of Data000.bin can be checked in the trash box holder, the data is unreadable (that is, substantially erased). However, on the virtual file system, the existence of the physically-erased file may be uncheckable.

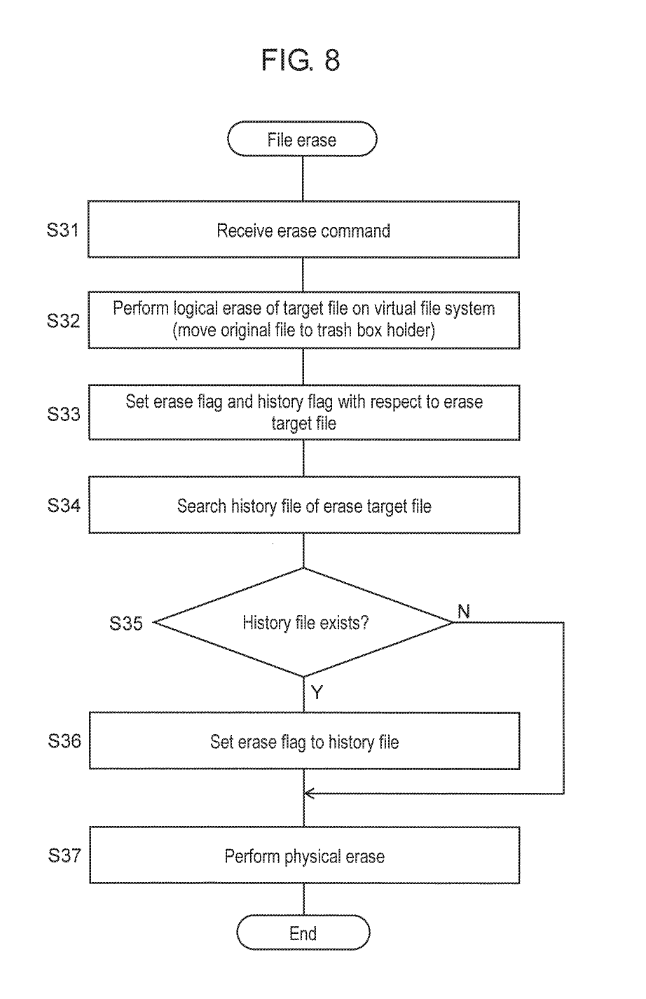

FIG. 8 is a flowchart illustrating a flow of the file erasing processing. The file erasing processing performed by information recording device 20 will more specifically be described with reference to the flowchart in FIG. 8.

When receiving the erase command in which the erase target file is specified from client terminal 10 (S31), controller 21 of information recording device 20 logically erases the erase target file on virtual file system 35 (S32), Specifically, on virtual file system 35, the erase target file is moved to the trash box holder from the holder in which the erase target file is currently stored.

Then, controller 21 sets the erase flag of the erase target file on the file information in database 33 (that is, the value of the erase flag is set to “1 (erase target)”) (S33). The history flag of the erase target file is also set (that is, the value of the history flag is set to “1 (history file)”) (S33).

Controller 21 refers to the history information in database 33 to search the history file associated with the erase target file (S34). When at least one piece of history file is searched (YES in S35), controller 21 sets the erase flag to the searched history file on the file information in database 33 (SW. In the case that the plurality of history files exist, the erase flag is set to all the history files.

Thus, in receiving the erase command, the erase target file is moved to the trash box holder on virtual file system 35, and the erase flag and the history flag are set. The erase flag is also set to the history file associated with the erase target file. In this state, only the logical erase is performed on virtual file system 35. Then, controller 21 performs the physical erase (S37).

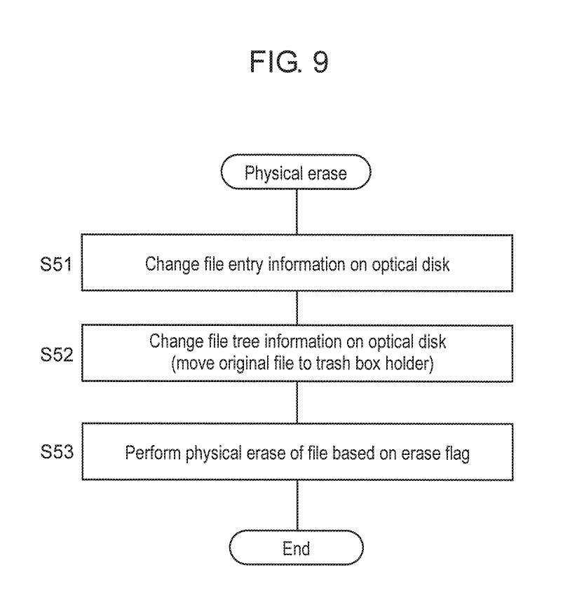

The physical erase operation performed by information recording device 20 will be described below with reference to a flowchart in FIG. 9. The physical erase is performed at timing arbitrarily specified by the user or based on the previously-set schedule.

Based on virtual file system 35, controller 21 of information recording device 20 issues an instruction to controller 52 of storage device 50 to change the file entry information on optical disk 101 (S51). Additionally, based on virtual file system 35, controller 21 of information recording device 20 issues an instruction to controller 52 of storage device 50 to change the file tree information on optical disk 101 (S52). That is, controller 21 of information recording device 20 issues the instruction to controller 52 of storage device 50 to change the file tree information such that the storage place of the erase target file becomes the trash box holder.

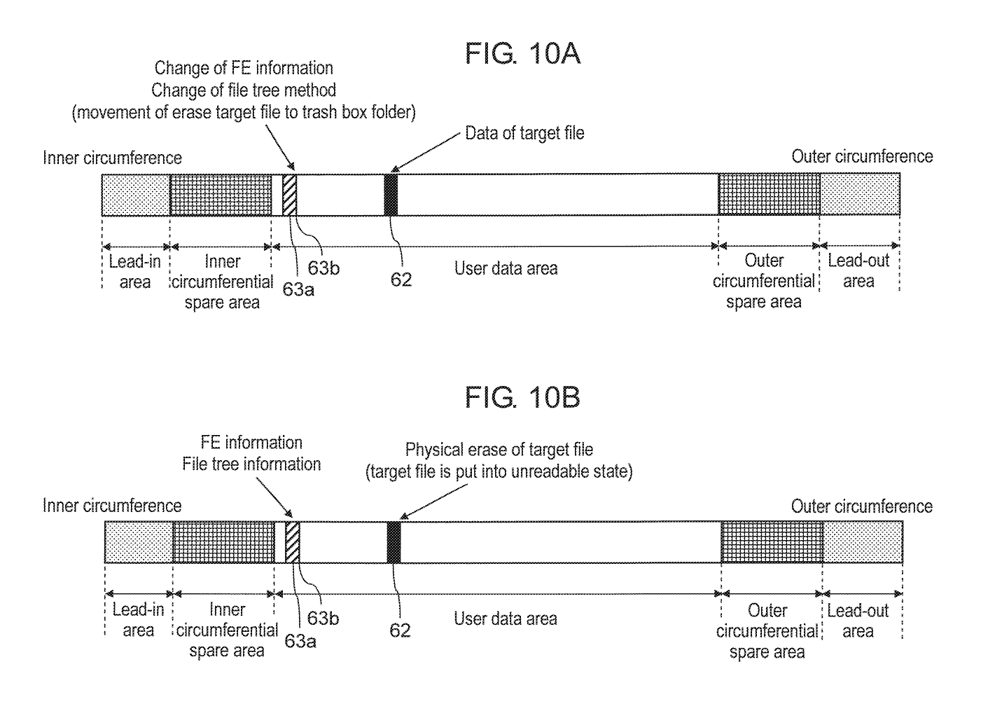

Controller 52 of storage device 50 changes the file entry information and the file tree information based on the instruction from controller 21 of information recording device 20. As illustrated in FIG. 10A, on optical disk 101, controller 52 of storage device 50 records changed file entry information 63a and changed file tree information 63b in the area different from the area where the original file entry information and original file tree information are stored. At this point, the entity data of the erase target file is not changed.

Then, controller 21 of information recording device 20 refers to the file information in database 33, and issues an instruction to controller 52 of storage device 50 to physically erase the file in which the erase flag is set to “1” (S53). In response to the instruction, controller 52 of storage device 50 physically erases the file on optical disk 101. In the case that the plurality of history files associated with the target file exist, controller 21 erases all the history files.

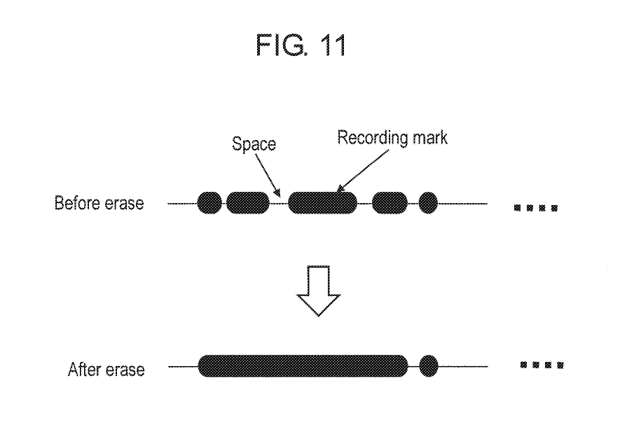

The physical erase is performed by putting the file to be erased into the unreproducible state. For example, the file to be erased is put into the unreproducible state by overwriting at least part of the data of the file using a predetermined erase pattern. That is, the file to be erased is put into the unreproducible state by overwriting at least one of the entity data, synchronization data, and error correction data of the file using the predetermined erase pattern. For example, as illustrated in FIG. 11, the overwrite is performed by deforming a recording mark constituting the data of the file to be erased into a longer recording mark in the recording layer of optical disk 101. The file cannot be read hereafter by deforming the recording mark, and the file is substantially erased.

Thus, the physical erase is performed on the file in which the erase flag is set to “1”. Hereinafter, the file on which the physical erase is already performed cannot be read. The physical erase may be performed at timing arbitrarily specified by the user, at previously-scheduled timing, or at the same time as the performance of the synchronization processing.

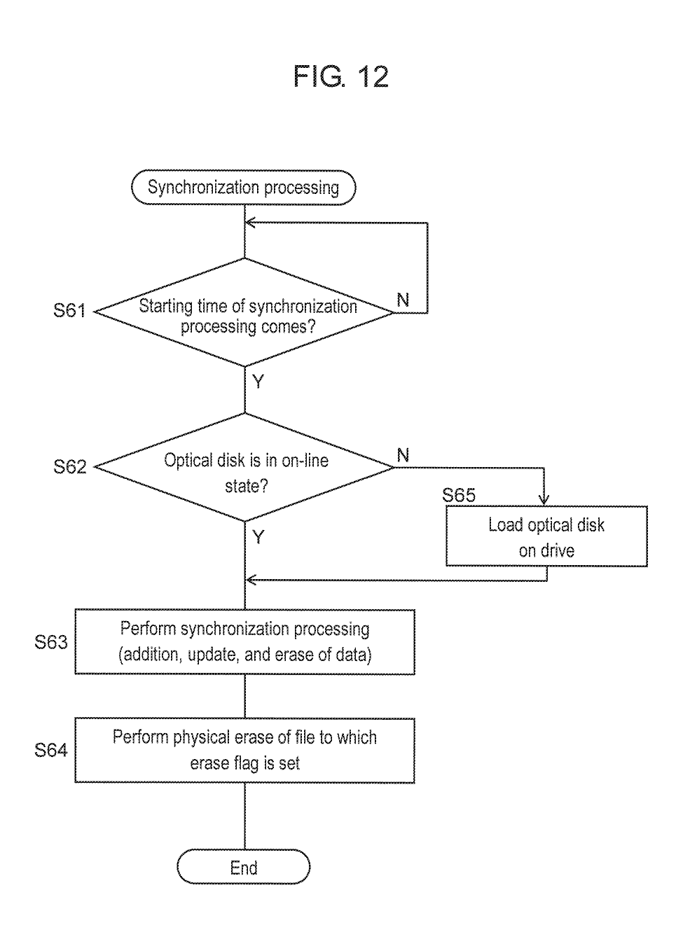

The physical erase processing in the synchronization processing performed in the previously-scheduled timing will be described below with reference to FIG. 12.

Using the function of scheduler 38, controller 21 determines whether a current clock time reaches a clock time the synchronization processing is started (S61). When it is determined that the current clock time reaches the clock time the synchronization processing is started (YES in S61), controller 21 starts the synchronization processing.

Controller 21 checks whether optical disk 101 is in an on-line state with storage device 50 (that is, whether optical disk 101 is loaded on optical disk drive 56) (S62). When optical disk 101 is not in the on-line state (NO in S62), controller 21 issues an instruction to storage device 50 to load optical disk 101 on optical disk drive 56 (S65).

Then, controller 21 performs the synchronization processing on optical disk 101 according to virtual file system 35 and cache 34 (S63) in the synchronization processing, controller 21 adds and updates the file (entity data), the file entry information, and the file tree information on optical disk 101 such that the data state managed by virtual file system 35 is reflected in optical disk 101. For example, as to the updated file, the data of the updated file is newly recorded on optical disk 101 as illustrated in FIG. 5. At the same time, the file entry information and the file tree information are updated and newly recorded such that the pre-update original file is renamed to be stored in the trash box holder. As to the erase target file, as illustrated in FIG. 10A, file entry information 63a and file tree information 63b are changed such that the erase target file is stored in the trash box holder on optical disk 101.

As described above, as to the erase of the file, when the synchronization processing is performed to reflect the content of virtual file system 35, only the erase target file is logically erased. That is, the erase target file is only moved to the trash box holder in terms of the management on optical disk 101.

After the synchronization processing, controller 21 refers to the file information in database 33, searches the file in which the erase flag is set to “1”, and issues an instruction to storage device 50 to physically erase the searched file (S64). Controller 52 of storage device 50 physically erases the file in which the erase flag is set to “1” on optical disk 101 according to the instruction from controller 21 of information recording device 20. The physically-erased file becomes unreadable (see FIG. 10B).

Thus, when the physical erase is performed in addition to the synchronization processing, the physical erase can continuously be performed while optical disk 101 is loaded on optical disk drive 56 for the purpose of the synchronization processing. It is not necessary to separately load optical disk 101 for the purpose of the erase processing, so that a loading waiting time and a loading frequency can be reduced. Therefore, efficiency of the processing of updating optical disk 101 can be improved as a whole.

### 1-3. Effect and the Like

As described above, information recording device 20 of the exemplary embodiment is the device that can erase the file (that is, the data) recorded in write-once optical disk 101. Information recording device 20 includes: data storage 22 in which database 33 is stored, database 33 managing data recorded in optical disk 101 and the history data associated with the file; and controller 21 that controls the recording, update, and erase of the file with respect to optical disk 101. The history file is the pre-update file when the file recorded in optical disk 101 is updated. Controller 21 determines, when the target file recorded in optical disk 101 is erased, whether at least one piece of history file associated with the target file exists (S35). Controller 21 erases, when at least one piece of history file associated with the target file exists, the target file and the history file associated with the target file on the optical disk (S33, S36, and S37).

Information recording device 20 of the exemplary embodiment can erase the data recorded in the write-once optical disk. Particularly, information recording device 20 automatically detects and erases not only the erase target data but also the history data associated with the erase target data. Therefore, user-friendliness can be improved, in the erase processing.

Database 33 may manage the erase flag indicating whether each of the target file and the history file is the erase target. When the target file recorded in optical disk 101 is erased, controller 21 may set the erase flag to the target file and the history file detected with respect to the target file in database 33 (S33 and S36). Controller 21 erases the target file and history file in which the erase flag indicating the erase target is set in predetermined timing (for example, timing arbitrarily specified by the user, or timing for performing the synchronization processing).

Whether the file is the erase target can be recognized by referring to the erase flag. Therefore, the file can physically be erased in arbitrary timing independently of timing for logically erasing the file.

When the addition or update of the data is performed on optical disk 101, controller 21 may temporarily store the data to be added or updated in cache 34, and then perform the synchronization processing of reflecting the data in cache 34 in optical disk 101. At this point, the target file and history file in which the erase flag indicating the erase target is set may physically be erased in timing for performing the synchronization processing. The physical erase is performed in the synchronization processing, which allows the reduction of the frequency of loading optical disk 101 on optical disk drive 56.

The exemplary embodiment also discloses the data erasing method for erasing the target file recorded in the write-once optical disk. In optical disk 101, after the file recorded in optical disk 101 is updated, the pre-updated file is managed as the history file for the updated file. The data erasing method includes: determining whether at least one piece of history file associated with the target file exists on optical disk 101 (S35); and, erasing, when at least one piece of history file exists, the target file and the history file associated with the target file (S33, S36, and S37).

### Other Exemplary Embodiment

The exemplary embodiment is described above as an illustrative example of the technology disclosed in the present disclosure. The technology of the present disclosure is not limited to the exemplary embodiment, but the technology can also be applied to exemplary embodiments in which the change, replacement, addition, and omission are suitably performed. A new exemplary embodiment can also be made by a combination of the components of the above exemplary embodiment.

Other exemplary embodiments will be exemplified below.

In the above exemplary embodiment, controllers 21 and 52 are the CPU or MPU that implements a predetermined function in conjunction with software. Alternatively, controllers 21 and 52 may be realized by a dedicated electronic circuit that is designed to implement the predetermined function. That is, controllers 21 and 52 can be realized by the CPU, the MPU, a DSP, an FPGA, and an ASIC.

In the above exemplary embodiment, for convenience, storage device 50 includes only one optical disk 101. Alternatively, storage device 50 may accommodate a plurality of optical disks, and switch the optical disk loaded on optical disk drive 56 using changer 54.

In the above exemplary embodiment, the file is described as an example of the erase target data. Alternatively, an object in which the use becomes increasingly widespread in SWIFT may be set to the erase target.

The exemplary embodiment is described above as an illustrative example of the technology disclosed in the present disclosure. For this reason, the accompanying drawings and the detailed description are provided.

The constituents described in the accompanying drawings and detailed description can include not only the component necessary for the solution of the problem but also the component that is not necessary for the solution of the problem but simply illustrates the technology. Therefore, it is noted that the unnecessary component is not immediately recognized to be necessary even if the unnecessary component is illustrated or described in the accompanying drawings and the detailed description.

Because the exemplary embodiment is used to illustrate the technology of the present disclosure, various changes, replacements, additions, and omissions can be made in claims or a range equivalent to the claims.

1. An information recording device that can erase data recorded in a write-once optical disk, the information recording device comprising:
a storage in which a database is stored, the database managing the data recorded in the optical disk and history data associated with the data; and
a controller that controls recording, update, and erase of the data with respect to the optical disk, wherein
the history data is pre-update data when the data recorded in the optical disk is updated,
the controller determines, when target data recorded in the optical disk is erased, whether at least one piece of history data associated with the target data exists, and the controller erases the target data and the history data associated with the target data on the optical disk when at least the one piece of history data associated with the target data exists.

2. The information recording device according to claim 1, wherein
the database manages an erase flag indicating whether each of the target data and the history data is an erase target,
the controller sets the erase flag to the target data and the history data associated with the target data in the database when erasing the target data recorded in the optical disk, and
the controller erases the target data and the history data to which the erase flag indicating the erase target is set at predetermined timing.

3. The information recording device according to claim 2, wherein
when adding or updating the data with respect to the optical disk, the controller temporarily stores data to be added or updated on a cache, and then performs synchronization processing of reflecting the data on the cache in the optical disk, and
the predetermined timing is timing for performing the synchronization processing.

4. The information recording device according to claim 2, wherein the predetermined timing is timing arbitrarily specified by a user.

5. The information recording device according to claim 1, wherein the controller erases the target data or the history data by putting the target data or the history data into an unreproducible state.

6. The information recording device according to claim 1, wherein the controller erases all the pieces of history data associated with the target data.

7. A data erasing method for erasing target data recorded in a write-once optical disk, pre-update data being managed as history data for post-update data after data recorded in the optical disk is updated on the optical disk, the data erasing method comprising:
determining whether at least one piece of history data associated with the target data exists on the optical disk; and
erasing the target data and the history data associated with the target data when at least the one piece of history data associated with the target data exists.

8. The data erasing method according to claim 7, further comprising:
managing the target data and the history data associated with the target data in a database while the target data and the history data associated with the target data are correlated with each other; and
setting an erase flag indicating whether each of the target data and the history data is an erase target in the database, wherein
in the erasing, the target data and the history data to which the erase flag indicating the erase target is set are erased at predetermined timing.

9. The data erasing method according to claim 8, further comprising:
storing temporarily data to be added or updated on a cache when addition or update of the data is performed with respect to the optical disk; and
performing synchronization processing of reflecting the data on the cache in the optical disk, wherein
the predetermined timing is timing for performing the synchronization processing.

10. The data erasing method according to claim 8, wherein the predetermined timing is timing arbitrarily specified by a user.

11. The data erasing method according to claim 7, wherein the target data or the history data is erased by putting the target data or the history data into an unreproducible state.

12. The data erasing method according to claim 7, wherein, in the erasing, all the pieces of history data associated with the target data are erased.
